(19) United States
(12) Patent Application Publication
(10) Pub. No.: US 2022/0327580 A1
(43) Pub. Date: Oct. 13, 2022

(54) METHOD AND APPARATUS FOR INTERACTING WITH IMAGE, AND MEDIUM AND ELECTRONIC DEVICE

(71) Applicant: BEIJING BYTEDANCE NETWORK TECHNOLOGY CO., LTD., Beijing (CN)

(72) Inventors: Xinghua ZHANG, Beijing (CN); Zesi CHEN, Beijing (CN); Xuan LI, Beijing (CN); Ruyu JIANG, Beijing (CN); Peng XU, Beijing (CN); Jin YANG, Beijing (CN); Jie ZHANG, Beijing (CN); Rongrong ZHENG, Beijing (CN)

(21) Appl. No.: 17/761,987

(22) PCT Filed: Aug. 14, 2020
(86) PCT No.: PCT/CN2020/109197

§ 371 Date: Mar. 18, 2022

(30) Foreign Application Priority Data
Sep. 19, 2019 (CN) 201910885989.1

(51) Int. Cl. G06Q 30/02; G06F 3/04845

(52) U.S. Cl. CPC G06Q 30/0277; G06Q 30/0276; G06F 3/04845

(57) ABSTRACT

A method and an apparatus for interacting with an image, a medium and an electronic device are provided. The method includes: acquiring a first image of a target object; acquiring a preset effect image and a preset processing parameter corresponding to the preset effect image; and synthesizing the first image into the preset effect image based on the preset processing parameter, to generate a synthesized image. Through the interaction between a user and an effect image, the advertisement is changed from a monotonous and boring thing into a fun thing, or even a gamified thing, so that the user has a stronger sense of participation and is even willing to participate, thereby improving the effect of the advertisement. By linking with the social account, the advertising scene is expanded, and followers are attracted to the social account of the advertiser, thereby enhancing the added value of advertising.

### CROSS REFERENCE OF RELATED APPLICATION

The present application claims priority to Chinese Patent Application No. 201910885989.1, titled “METHOD AND APPARATUS FOR INTERACTING WITH IMAGE, AND MEDIUM AND ELECTRONIC DEVICE”, filed on Sep. 19, 2019, with the China National Intellectual Property Administration, which is incorporated herein by reference in its entirety.

### FIELD

The present disclosure relates to the technical field of computers, and in particular to a method and an apparatus for interacting with an image, a medium and an electronic device.

### BACKGROUND

Advertising is a means of publicity to transmit information to the public openly and widely through a certain form of media for a specific need. Information distribution advertisements are mainly broadcast advertisements.

Broadcast advertisements include outdoor advertisements, indoor advertisements and advertisements in elevators, and are shown in rolling pictures, texts or videos. At present, the broadcast advertisements include outdoor advertisements, indoor advertisements and advertisements in elevators. These advertisements are in pictures, texts or simply played, and users passively receive advertisement information and fail to actively participate in and browse the advertisement information. Due to the flood of information, users fail to pay attention to information effectively within a certain time period. Therefore, advertisers distribute a large amount of advertising information, forming a visual bombardment, which makes a little impression on users. However, most of the advertisements are forgotten in a fleeting moment.

However, current interactive advertisements only provide some simple interactions, such as information query, somatosensory operation and 3D projection. These interactions fail to arouse an interest of an advertisement object in the advertisement.

### SUMMARY

This summary is provided to introduce concepts in a simplified form that are described in detail in the detailed description that follows. This summary is neither intended to identify key features or essential features of the claimed technical solutions, nor intended to limit the scope of the claimed technical solutions.

A method and an apparatus for interacting with an image, a medium and an electronic device are provided according to the present disclosure, solve at least one of the above-mentioned technical problems. Technical solutions are as follows.

A method for interacting with an image is provided according to a first aspect of embodiments of the present disclosure. The method includes: acquiring a first image of a target object; acquiring a preset effect image and a preset processing parameter corresponding to the preset effect image; and synthesizing the first image into the preset effect image based on the preset processing parameter, to generate a synthesized image.

An apparatus for interacting with an image is provided according to a second aspect of the embodiments of the present disclosure. The apparatus includes a first image acquiring unit, a preset effect image acquiring unit and a synthesizing unit. The first image acquisition unit is configured to acquire a first image of a target object. The preset effect image acquiring unit is configured to acquire a preset effect image and a preset processing parameter corresponding to the preset effect image. The synthesizing unit is configured to synthesize the first image into the preset effect image based on the preset processing parameter, to generate a synthesized image.

A computer-readable storage medium is provided according to a third aspect of the embodiments of the present disclosure. The computer-readable storage medium stores a computer program that, when executed by a processor, implements the method for interacting with an image as described in the first aspect.

An electronic device is provided according to a fourth aspect of the embodiments of the present disclosure. The electronic device includes one or more processors, one or more display devices and a corresponding camera, and a storage device configured to store one or more programs. The one or more programs, when executed by the one or more processors, cause the one or more processors to implement the method for interacting with an image as described in the first aspect.

Compared with the conventional technology, the above technical solutions of the embodiments of the present disclosure have at least the following beneficial effects.

A method and an apparatus for interacting with an image, a medium and an electronic device are provided according to the present disclosure. The method includes: acquiring a first image of a target object; acquiring a preset effect image and a preset processing parameter corresponding to the preset effect image; and synthesizing the first image into the preset effect image based on the preset processing parameter, to generate a synthesized image.

Through the interaction between a user and an effect image, the advertisement is changed from a monotonous and boring thing into a fun thing, or even a gamified thing, so that the user has a stronger sense of participation and is even willing to participate, thereby improving the effect of the advertisement. By linking with the social account, the advertising scene is expanded, and followers are attracted to the social account such as an official account of the advertiser, thereby enhancing the added value of advertising for the advertiser. With the various effect image set issued by the GPS, the advertisement varies with areas, so as to improve the pertinence of the advertising crowd, and the conversion effect and the value of the advertisement. In addition to advertisements, the present disclosure is also generally applicable to brand promotion, corporate promotion, and the like.

### BRIEF DESCRIPTION OF THE DRAWINGS

The above and other features, advantages and aspects of the embodiments of the present disclosure become more apparent in conjunction with the accompanying drawings and with reference to the following detailed description. Throughout the drawings, the same or similar reference numbers refer to the same or similar elements. It should be understood that the drawings are illustrative and that the components and elements are unnecessarily drawn to scale. In the drawings:

FIG. 1 is a flowchart showing a method for interacting with an image according to an embodiment of the present disclosure;

FIG. 2 shows a multimedia interactive device of the method for interacting with an image according to an embodiment of the present disclosure;

FIG. 3 shows an image synthesized with the method for interacting with an image according to an embodiment of the present disclosure;

FIG. 4 is block diagram showing units of an apparatus for interacting with an image according to an embodiment of the present disclosure; and

FIG. 5 is a schematic diagram showing connection in an electronic device according to an embodiment of the present disclosure.

### DETAILED DESCRIPTION OF EMBODIMENTS

Embodiments of the present disclosure are described in more detail below with reference to the accompanying drawings. Although certain embodiments of the present disclosure are shown in the drawings, it should be understood that the present disclosure may be embodied in various forms and should not be construed as limiting the embodiments set forth herein. Instead, these embodiments are provided for a thorough and complete understanding of the present disclosure. It should be understood that the drawings and embodiments of the present disclosure are only for illustration, and are not intended to limit the protection scope of the present disclosure.

It should be understood that various steps to be described in method embodiments of the present disclosure may be performed in a different order and/or in parallel. Furthermore, the method embodiments may include additional steps and/or an illustrated step may be not performed. The scope of the present disclosure is not limited in this regard.

The term “including” and variations thereof herein are open-ended inclusions, that is, “including but not limited to”. The term “based on” indicates “based at least in part on”. The term “an embodiment” indicates “at least one embodiment”; the term “another embodiment” means “at least one additional embodiment”. The term “some embodiments” indicates “at least some embodiments”. Definitions of other terms are given in the description below.

It should be noted that terms such as “first” and “second” mentioned in the present disclosure are only used to distinguish devices, modules or units, rather than to limit the order or interdependence of functions implemented by these devices, modules or units.

It should be noted that determiner such as “a” and “a plurality of” mentioned in the present disclosure are illustrative rather than restrictive. It should be understood by those skilled in the art that unless the context clearly dictates otherwise, the terms “a” and “a plurality” should be understood as “one or more”.

A name of a message or a piece of information exchanged between multiple devices in the embodiments of the present disclosure are only for illustration, rather than intended to limit the scope of the message or information.

Optional embodiments of the present disclosure are described in detail below with reference to the drawings.

A first embodiment according to the present disclosure is an embodiment of a method for interacting with an image.

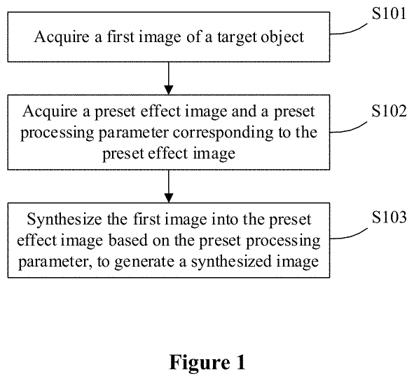

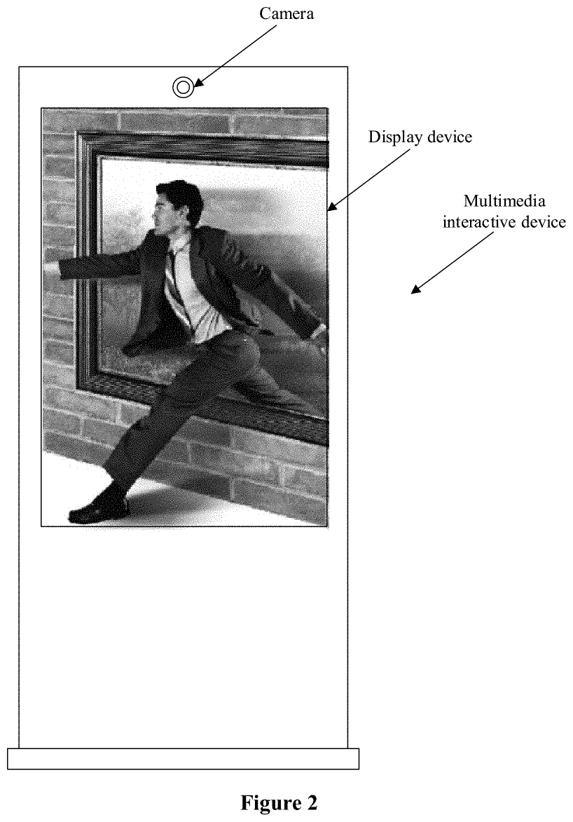

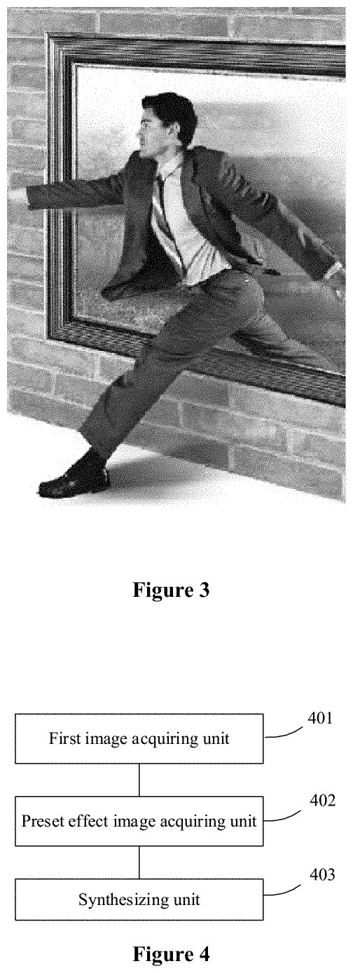

The embodiment of the present disclosure is described in detail below with reference to FIG. 1, which is a flowchart showing a method for interacting with an image according to an embodiment of the present disclosure. FIG. 2 shows a multimedia interactive device of the method for interacting with an image according to an embodiment of the present disclosure. FIG. 3 shows an image synthesized with the method for interacting with an image according to an embodiment of the present disclosure.

Referring to FIG. 2, the method described in the embodiment of the present disclosure is applied to a multimedia interactive device. The multimedia interactive device includes a display device and a camera, for example, an advertising machine.

Referring to FIG. 1, in step S101, a first image of a target object is acquired.

The target object refers to an object that interacts with the multimedia interactive device in the embodiment of the present disclosure. For example, a user involved in the interaction.

The first image is a partial image of the target object after a background image is filtered out. For example, the first image is a head image of the user.

The acquisition of the first image of the target object includes the following steps S101-1 to S101-2.

In step S101-1, a second image of the target object is captured.

The second image refers to an image including a target object and a background within the imaging range. For example, a camera of a multimedia interactive device placed in a mall automatically captures an image including a good and a user who is walking past the multimedia interactive device. The camera may capture one image to synthesize an interactive image. Alternatively, the camera captures an image multiple times in succession, to synthesize a succession of interactive images, which are not limited herein.

Optionally, the capturing of the second image of the target object includes the following steps S101-1-1 to S101-1-2.

In step S101-1-1, operation information is acquired.

In step S101-1-2, in a case that the operation information matches preset selfie trigger information, the second image of the target object is captured when a preset delay time period elapses.

For example, in a case that the user is satisfied with the synthesized image and wishes to capture the synthesized image at an appropriate position and angle, the user clicks an automatic capture button on the display device, that is, the operation information is triggered. In a case that the operation information acquired by the multimedia interactive device matches the preset selfie trigger information, countdown starts. In this case, the user participating in the interaction selects an appropriate position and angle within the preset delay time period, and waits for the preset delay time period to elapse to trigger the camera function.

In step S101-2, the first image is extracted from the second image based on a preset extraction parameter.

The preset extraction parameter limits an extraction range of a to-be-extracted target object. For example, the preset extraction parameter limits how to extract a head image of the user.

In step S102, a preset effect image and a preset processing parameter corresponding to the preset effect image are acquired.

The preset effect image is a default effect image. Display content varies from effect image to effect image, the preset processing parameter for synthesizing the first image into the preset effect image to achieve interesting effect also vary from effect image to effect image. Therefore, the preset effect image is in one-to-one correspondence with the preset processing parameter.

The preset processing parameter includes a preset filter parameter and/or a preset synthesis area parameter in the preset effect image.

The preset synthesis area parameter refers to an area parameter for synthesizing the first image in the preset effect image.

The preset filter parameter refers a display effect parameter for modifying the synthesized image.

In step S103, the first image is synthesized into the preset effect image based on the preset processing parameter, to generate a synthesized image, as shown in FIG. 3.

Optionally, in order to increase the interactive effect and enjoyment of the embodiment of the present disclosure, before the acquisition of the preset effect image and the preset processing parameter corresponding to the preset effect image, the method further includes the following steps S104 to S105.

In step S104, operation information is acquired.

In step S105, in a case that the operation information matches preset switching information, the preset effect image is switched from a first effect image to a second effect image.

The preset switching information includes: preset sliding information in a sensing device, preset gesture information in a capture area, trigger information of a preset button, and/or trigger information of a preset display object.

For example, the sensing device includes a touch screen. Sliding information is generated by swiping across the touch screen. In a case that the sliding information matches the preset sliding information, an instruction to switch the effect image is triggered. The capture area is a photographing area of the camera, and the camera acquires gesture information in the photographing area. In a case that the gesture information matches the preset gesture information, the instruction to switch the effect image is triggered. The capture area is a sensing area of a distance sensor, and the distance sensor acquires obstacle (for example, gesture) information in the sensing area. In a case that the gesture information matches the preset gesture information, the instruction to switch the effect image is triggered. The multimedia interactive device includes a preset button. When the preset button is pressed, the instruction to switch the effect image is triggered. A preset display object (for example, a button) is displayed on the display device, and when the preset display object is clicked, the instruction to switch the effect image is triggered.

In this case, the second effect image serves as the preset effect image. That is, the second effect image is the default effect image. The preset effect image is switched from the first effect image to the second effect image. The preset processing parameter is also switched from the first processing parameter corresponding to the first effect image to a second processing parameter corresponding to the second effect image.

Finally, the first image is synthesized into the second effect image based on the second processing parameter, to generate a synthesized image.

A user participating in the interaction selects an effect image through interaction according to preferences, so that a monotonous and boring thing becomes a fun thing, or even a gamified thing. Therefore, the user has a stronger sense of participation and even is willing to participate. The method according to the embodiment of the present disclosure is applied to advertising, and an advertisement image of the advertiser serves as the effect image. An image of the user participating in the interaction is synthesized into the advertisement image, so that the advertisement is impressive, thereby improving performance of the advertisement.

Optionally, the method further includes the following step S106. In step S106, the synthesized image is uploaded.

The acquired synthesized image is uploaded to a management server, for example, an advertisement management server for unified management.

Optionally, after the synthesized image is uploaded, the method further includes the following step S107.

In step S107, client connection information returned in response to the synthesized image is received and displayed, so that the target object acquires the client connection information through a terminal and establishes a connection with presentation information of the client.

The client is an object associated with content in the effect image, for example, the advertiser.

The client connection information is for establishing a connection with the presentation information of the client. The presentation information of the client includes a website or self-media information of the client. For example, the client connection information includes a QR code of a social account of the client. The social account includes WeChat, QQ, Weibo, Facebook, Twitter, and Instagram. The user participating in the interaction scans the QR code via an applet within a preset scanning time period, to establish a connection with the presentation information of the client, so that the client can push advertisements or dynamic information through the presentation information.

By linking with the social account, the advertising scene is expanded, and followers are attracted to the social accounts such as the official account of the advertiser, thereby enhancing the added value of advertising for the advertiser.

After the user participating in the interaction completes scanning and follows the official account, the applet receives a link to download a photo pushed from a background server. The user participating in the interaction can download the synthesized image and save the synthesized image.

Optionally, the method further includes the following step S108. In step S108, the synthesized image is printed.

Optionally, the preset effect image is one of effect images stored in an effect image set.

The effect image set may be downloaded to the multimedia interactive device and stored locally. Alternatively, the effect image set is stored in a remote server, and the preset effect image is acquired and stored in a local memory as required.

The method further includes the following steps S109 and S110.

In step S109, geographic location information is acquired.

The geographic location information includes satellite positioning information and base station positioning information.

In step S110, an effect image set associated with the geographic location information is acquired based on the geographic location information, and an effect image in the effect image set is designated as the preset effect image.

The content of the effect image in the effect image set is associated with a geographic location where the multimedia interactive device is placed, the advertisement varies with areas, so as to improve the pertinence of the advertising crowd, and the conversion effect and the value of the advertisement.

Through the interaction between a user and an effect image, the advertisement is changed from a monotonous and boring thing into a fun thing, or even a gamified thing, so that the user has a stronger sense of participation and is even willing to participate, thereby improving the effect of the advertisement. By linking with the social account, the advertising scene is expanded, and followers are attracted to the social account such as an official account of the advertiser, thereby enhancing the added value of advertising for the advertiser. With the various effect image set issued by the GPS, the advertisement varies with areas, so as to improve the pertinence of the advertising crowd, and the conversion effect and the value of the advertisement. In addition to advertisements, the present disclosure is also generally applicable to brand promotion, corporate promotion, and the like.

Corresponding to the first embodiment of the present disclosure, an apparatus for interacting with an image is provided according to a second embodiment of the present disclosure. Since the second embodiment is substantially similar to the first embodiment, the description is relatively simple, and for relevant parts, reference is made to the corresponding description of the first embodiment. The apparatus embodiments described below are merely illustrative.

FIG. 4 shows an embodiment of an apparatus for interacting with an image according to the present disclosure. FIG. 4 is block diagram showing units of the apparatus for interacting with an image according to the embodiment of the present disclosure.

Referring to FIG. 4, the apparatus for interacting with an image according to the present disclosure includes: a first image acquiring unit 401, a preset effect image acquiring unit 402, and a synthesizing unit 403.

The first image acquisition unit 401 is configured to acquire a first image of a target object.

The preset effect image acquiring unit 402 is configured to acquire a preset effect image and a preset processing parameter corresponding to the preset effect image.

The synthesizing unit 403 is configured to synthesize the first image into the preset effect image based on the preset processing parameter, to generate a synthesized image.

Optionally, the first image acquiring unit 401 includes a capturing subunit and an extracting subunit.

The capturing subunit is configured to capture a second image of the target object.

The extracting subunit is configured to extract the first image from the second image based on a preset extraction parameter.

Optionally, the capturing subunit includes: a first operation information acquiring subunit and a first matching subunit.

The first operation information acquisition subunit is configured to acquire operation information.

The first matching subunit is configured to capture the second image of the target object when a preset delay time period elapses in a case that the operation information matches preset selfie trigger information.

Optionally, the preset effect image acquiring unit 402 includes: a second operation information acquiring subunit and a second matching subunit.

The second operation information acquiring subunit is configured to acquire operation information.

The second matching subunit is configured to switch the preset effect image from the first effect image to a second effect image in a case that the operation information matches preset switching information.

Optionally, the preset switching information includes: preset sliding information in a sensing device, preset gesture information in a capture area, trigger information of a preset button, and/or trigger information of a preset display object.

Optionally, the apparatus further includes an uploading unit configured to upload the synthesized image.

Optionally, the apparatus further includes: a client connection information receiving and displaying unit, configured to receive and display client connection information returned in response to the synthesized image, so that the target object acquires the client connection information through a terminal and establishes a connection with presentation information of the client.

Optionally, the preset effect image is one of effect images stored in an effect image set.

The apparatus further includes a geographic location information acquiring unit and an effect image set acquiring unit.

The geographic location information acquiring unit is configured to acquire geographic location information.

The effect image set acquiring unit is configured to acquire based on the geographic location information an effect image set associated with the geographic location information, and designate an effect image in the effect image set as the preset effect image.

Optionally, the apparatus further includes a printing unit configured to print the synthesized image.

Optionally, the preset processing parameter includes a preset filter parameter and/or a preset synthesis area parameter in the preset effect image.

Through the interaction between a user and an effect image, the advertisement is changed from a monotonous and boring thing into a fun thing, or even a gamified thing, so that the user has a stronger sense of participation and is even willing to participate, thereby improving the effect of the advertisement. By linking with the social account, the advertising scene is expanded, and followers are attracted to the social account such as an official account of the advertiser, thereby enhancing the added value of advertising for the advertiser. With the various effect image set issued by the GPS, the advertisement varies with areas, so as to improve the pertinence of the advertising crowd, and the conversion effect and the value of the advertisement. In addition to advertisements, the present disclosure is also generally applicable to brand promotion, corporate promotion, and the like.

An electronic device is provided according to a third embodiment of the present disclosure. The device is applied to the method for interacting with an image. The electronic device includes: at least one processor; at least one display device and a camera; and a memory communicatively connected to the at least one processor.

The memory stores instructions executable by the one processor. The instructions are executed by the at least one processor to cause the at least one processor to perform the method for interacting with an image as described in the first embodiment.

A computer storage medium for interacting with an image is provided according to a fourth embodiment of the present disclosure. The computer storage medium stores computer-executable instructions. The computer-executable instructions are configured to implement the method for interacting with an image as described in the first embodiment.

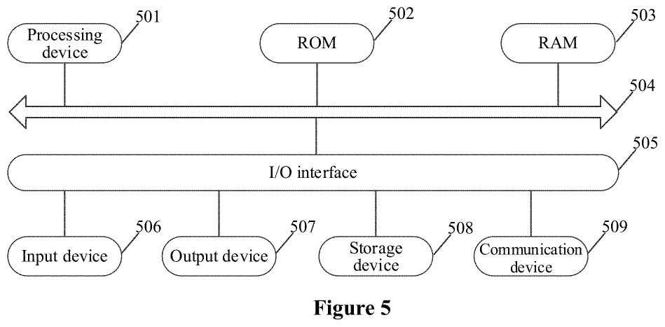

Reference is made to FIG. 5, which is a schematic structural diagram of an electronic device for implementing embodiments of the present disclosure. The terminal device in the embodiments of the present disclosure may include but is not limited to a mobile terminal such as a mobile phone, a notebook computer, a digital broadcast receiver, a PDA (personal digital assistant), a PAD (tablet), a PMP (portable multimedia player), an in-vehicle terminal (for example, an in-vehicle navigation terminal), and a fixed terminal such as a digital TV, a desktop computer. The electronic device shown in FIG. 5 is only an example, and should not impose any limitation on the function and scope of use of the embodiments of the present disclosure.

As shown in FIG. 5, the electronic device may include a processing device (such as a central processing unit and a graphics processor) 501. The processing device 501 performs various appropriate actions and processing according to a program stored in a read only memory (ROM) 502 or a program loaded into a random-access memory (RAM) 503 from a storage device 508. Various programs and data required for operation of the electronic device are also stored in the RAM 503. The processing device 501, the ROM 502, and the RAM 503 are connected to each other via a bus 504. An input/output (I/O) interface 505 is also connected to the bus 504.

Generally, the following devices are also connected to the I/O interface 505: an input device 506 including, for example, a touchscreen, a touchpad, a keyboard, a mouse, a camera, a microphone, an accelerometer and a gyroscope; an output device 507 including, for example, a liquid crystal display (LCD), a speaker, and a vibrator; a storage device 508 including, for example, a magnetic tape and a hard disk; and a communication device 509. The communication device 509 allows the electronic device to communicate wirelessly or by wire with other device to exchange data. Although FIG. 5 shows an electronic device having various devices, it should be understood that not all of the devices shown are required to be implemented or included. Alternatively, more or fewer devices may be implemented or provided.

In particular, according to embodiments of the present disclosure, the processes described above with reference to the flowcharts may be implemented as computer software programs. For example, a computer program product including a computer program carried on a non-transitory computer readable medium is provided according to embodiments of the present disclosure, and the computer program includes program code for performing the method illustrated in the flowcharts. In such embodiments, the computer program may be downloaded and installed from the network via the communication device 509, or installed from the storage device 508, or from the ROM 502. When the computer program is executed by the processing device 501, the above-mentioned functions defined in the method according to the embodiments of the present disclosure is implemented.

It should be noted that the computer-readable medium mentioned above in the present disclosure may be a computer-readable signal medium or a computer-readable storage medium, or any combination of the two. The computer readable storage medium may be, for example, but not limited to, an electrical, magnetic, optical, electromagnetic, infrared, or semiconductor system, apparatus or device, or a combination of any of the above. Specific examples of the computer readable storage medium may include, but are not limited to, an electrical connection with one or more wires, a portable computer disk, a hard disk, a random-access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above. In the present disclosure, the computer-readable storage medium may be any tangible medium that contains or stores a program capable of being used by or in conjunction with an instruction execution system, apparatus, or device. In the present disclosure, however, the computer-readable signal medium may include a data signal propagated in a baseband or as part of a carrier wave, with computer-readable program code embodied thereon. Such propagated data signal may be in a variety of forms, including but not limited to an electromagnetic signal, an optical signal, or any suitable combination of the foregoing. The computer-readable signal medium may also be any computer-readable medium other than the computer-readable storage medium. The computer-readable signal medium can transmit, propagate, or transport the program for use by or in connection with the instruction execution system, apparatus, or device. The program code embodied on the computer-readable medium may be transmitted through suitable medium including, but not limited to, an electrical wire, an optical fiber cable, an RF (radio frequency) or the like, or any suitable combination of the foregoing.

In some embodiments, the client and the server perform communication based on any currently known or to be developed network protocol such as HTTP (hypertext transfer protocol), and may be interconnected with any form or medium of digital data communication (for example, a communication network). Examples of the communication network include a local area network (“LAN”), a wide area network (“WAN”), the global network (for example, the Internet), and a peer-to-peer network (for example, the ad hoc peer-to-peer network), as well as any currently known or to be developed network.

The above computer-readable medium may be included in the above electronic device, or may be separate from the electronic device.

The computer program code for carrying out operations of the present disclosure may be written in one or more programming languages, or a combination thereof. Such programming languages include, but are not limited to, object-oriented programming languages such as Java, Smalltalk, C++, and conventional procedural programming languages such as the “C” language or the like. The program code may be executed entirely on a user computer, partly on a user computer, as a stand-alone software package, partly on a user computer and partly on a remote computer, or entirely on a remote computer or server. In the case of a remote computer, the remote computer may be connected to the user computer through any kind of network, including a local area network (LAN) or a wide area network (WAN), or may be connected to an external computer (for example, through an Internet connection provided by an Internet service provider).

The flowcharts and block diagrams in the drawings illustrate the architecture, functionality, and operation of possible implementations of the system, the method and the computer program product according to embodiments of the present disclosure. In this regard, each block in the flowcharts or block diagrams represents a module, a program segment, or a portion of code that contains one or more executable instructions for implementing specified logical functions. It should also be noted that, in some alternative implementations, the functions noted in the blocks may be implemented in an order different from the order noted in the drawings. For example, two blocks shown in succession may, in fact, be performed substantially concurrently, or may sometimes be performed in a reverse order, depending upon the functionality involved. It should be also noted that each block in the block diagrams and/or flowcharts, and a combination of blocks in the block diagrams and/or flowcharts, may be implemented by a dedicated hardware-based system that performs specified functions or operations, or may be implemented by a combination of the dedicated hardware and computer instructions.

The units in the embodiments of the present disclosure may be implemented by software or hardware. The name of a unit does not, in any case, qualify the unit itself.

The functions described herein above may be implemented, at least in part, by one or more hardware logic components. For example, without limitation, available hardware logic components include: a field programmable gate array (FPGA), an application specific integrated circuit (ASIC), an application specific standard product (ASSP), a system on chip (SOCs), a complex programmable logical device (CPLDs) and the like.

Throughout the present disclosure, a machine-readable medium may be a tangible medium that may contain or store a program for use by or in connection with the instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. Specific examples of the machine-readable storage medium include an electrical connection based on one or more wires, a portable computer disk, a hard disk, a random-access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above.

The above description shows merely preferred embodiments of the present disclosure and an illustration of the technical principles employed. Those skilled in the art should understand that the scope of disclosure involved in the present disclosure is not limited to the technical solutions formed by the specific combination of the above technical features but covers other technical solutions formed by any combination of the above technical features or their equivalents without departing from the above disclosed concept, for example, technical solutions formed by replacing the above features with the technical features disclosed in (but not limited to) the present disclosure with similar functions.

Additionally, although operations are described in a particular order, the operations are unnecessarily performed in the particular order as shown or in a sequential order. Under certain circumstances, multitasking and parallel processing may be advantageous. Likewise, although the above discussion contains several implementation-specific details, these should not be construed as limitations on the scope of the present disclosure. Some features that are described in the context of separate embodiments may be implemented in combination in a single embodiment. Conversely, various features that are described in the context of a single embodiment may also be implemented in multiple embodiments separately or in any suitable sub-combination.

Although the subject matter has been described in language specific to structural features and/or logical acts of method, it should be understood that the subject matter defined in the appended claims is unnecessarily limited to the specific features or acts described above. In fact, the specific features and acts described above are merely example forms of implementing the claims.

What is claimed is:

1. A method for interacting with an image, comprising:
acquiring a first image of a target object;
acquiring a preset effect image and a preset processing parameter corresponding to the preset effect image; and
synthesizing the first image into the preset effect image based on the preset processing parameter, to generate a synthesized image.

2. The method according to claim 1, wherein the acquiring a first image of the target object comprises:
capturing a second image of the target object; and
extracting the first image from the second image based on a preset extraction parameter.

3. The method according to claim 2, wherein the capturing a second image of the target object comprises:
acquiring operation information; and
capturing the second image of the target object when a preset delay time period elapses, in a case that the operation information matches preset selfie trigger information.

4. The method according to claim 1, further comprising:
before acquiring a preset effect image and a preset processing parameter corresponding to the preset effect image:
acquiring operation information; and
switching the preset effect image from a first effect image to a second effect image in a case that the operation information matches preset switching information.

5. The method according to claim 4, wherein the preset switching information comprises:
preset sliding information in a sensing device;
preset gesture information in a capture area;
trigger information of a preset button; and/or
trigger information of a preset display object.

6. The method of claim 1, further comprising:
uploading the synthesized image; and
receiving and displaying client connection information returned in response to the synthesized image, for the target object to acquire the client connection information through a terminal and establish a connection with presentation information of a client.

7. The method according to claim 1, wherein the preset effect image is one of effect images stored in an effect image set, and the method further comprises:
acquiring geographic location information; and
acquiring based on the geographic location information an effect image set associated with the geographic location information, and designating an effect image in the effect image set as the preset effect image.

8. The method according to claim 1, wherein the preset processing parameter comprises:
a preset filter parameter; and/or
a preset synthesis area parameter in the preset effect image.

9. An apparatus for interacting with an image, comprising:
at least one processor; and
at least one memory storing instructions that upon execution by the at least one processor cause the apparatus to:
acquire a first image of a target object;
acquire a preset effect image and a preset processing parameter corresponding to the preset effect image; and
synthesize the first image into the preset effect image based on the preset processing parameter, to generate a synthesized image.

10. A computer-readable non-transitory storage medium on which a computer program is stored, wherein the program, when executed by a computer, cause the computer to:
acquire a first image of a target object;
acquire a preset effect image and a preset processing parameter corresponding to the preset effect image; and
synthesize the first image into the preset effect image based on the preset processing parameter, to generate a synthesized image.

11. (canceled)

12. The apparatus of claim 9, the at least one memory further storing instructions that upon execution by the at least one processor cause the apparatus to:
capture a second image of the target object; and
extract the first image from the second image based on a preset extraction parameter.

13. The apparatus of claim 12, the at least one memory further storing instructions that upon execution by the at least one processor cause the apparatus to:
acquire operation information; and
capture the second image of the target object when a preset delay time period elapses, in a case that the operation information matches preset selfie trigger information.

14. The apparatus of claim 9, the at least one memory further storing instructions that upon execution by the at least one processor cause the apparatus to:
acquire operation information; and
switch the preset effect image from a first effect image to a second effect image in a case that the operation information matches preset switching information.

15. The apparatus of claim 14, wherein the preset switching information comprises:
preset sliding information in a sensing device;
preset gesture information in a capture area;
trigger information of a preset button; and/or
trigger information of a preset display object.

16. The apparatus of claim 9, the at least one memory further storing instructions that upon execution by the at least one processor cause the apparatus to:
upload the synthesized image; and
receive and displaying client connection information returned in response to the synthesized image, for the target object to acquire the client connection information through a terminal and establish a connection with presentation information of a client.

17. The apparatus of claim 9, the at least one memory further storing instructions that upon execution by the at least one processor cause the apparatus to:
acquire geographic location information; and
acquire based on the geographic location information an effect image set associated with the geographic location information, and designating an effect image in the effect image set as the preset effect image.

18. The apparatus of claim 9, wherein the preset processing parameter comprises:
a preset filter parameter; and/or
a preset synthesis area parameter in the preset effect image.
